(19) United States
(12) Patent Application Publication
(10) Pub. No.: US 2024/0418982 A1
(43) Pub. Date: Dec. 19, 2024

(54) LASER SCANNER

(71) Applicant: AUTONICS CORPORATION, Haeundae-gu, Busan (KR)

(72) Inventors: Hyeok Lae PARK, Bucheon-si (KR); Seung Min YOO, Seoul (KR)

(73) Assignee: AUTONICS CORPORATION, Haeundae-gu, Busan (KR)

(21) Appl. No.: 18/706,463

(22) PCT Filed: Dec. 2, 2022
(86) PCT No.: PCT/IB2022/061678

§ 371 Date: May 1, 2024

(30) Foreign Application Priority Data
Nov. 11, 2021 (KR) 10-2021-0155106

(51) Int. Cl. G02B 26/10; G01S 7/481

(52) U.S. Cl. CPC G02B 26/10; G01S 7/4817

(57) ABSTRACT

A laser scanner according to an embodiment of the present invention comprises: a housing; a window coupled to the upper surface of the housing; a motor mounted on the inner upper end of the window; a mirror slantly connected to the rotary shaft of the motor so as to reflect light; a light source arranged under the mirror so as to emit a laser beam toward the mirror; a PCB which is erected in the lateral direction of the mirror and which has an opening through which the laser beam reflected from the mirror passes; a reference sheet which is erected inside the window, and which is erected at a point separated from the PCB in the horizontal direction so as to spread and reflect the laser beam having passed through the opening; a light-transmissive lens arranged between the light source and the mirror so as to standardize, as parallel light, the laser beam emitted from the light source; a light-receiving element for receiving the laser beam, which is diffusely reflected from the reference sheet so as to pass through the opening; and a light-receiving lens for concentrating, at the light-receiving element, the laser beam, which is diffusely reflected from the reference sheet so as to pass through the opening.

### TECHNICAL FIELD

The present invention relates to a laser scanner.

### BACKGROUND ART

Laser scanners are widely used in distance measurement, in which a measurement system requires a large horizontal angle area, and are especially widely applied in the fields of safety technology for monitoring hazards.

Laser light is periodically irradiated to a monitoring area (or scanning area) from the laser scanner, and the irradiated light is reflected from an object, which exists in the monitoring area and then is received to the laser scanner. A time for which it takes for the emitted light to be received is measured to calculate a distance from the laser scanner to the object, a signal of an encoder is read to calculate an angle of the object, thereby determining a final position of the object.

In the laser scanner disposed in the prior art below, a mirror rotates at a constant speed, and the laser emitted from a light source is reflected by the mirror, and then, laser light is irradiated horizontally to the monitoring area. In addition, the laser scanner may be divided into a monitoring area (or scan area) and a light reference area (beam reference area) on a horizontal plane, and also, the monitoring area may be approximately 270 degrees, and the light reference area may be a remaining 90 degrees. The 270 degrees refer to a scan angle, and the 90 degrees refer to a non-scan angle.

Thus, the position and distance of the object or obstacle on the monitoring area within a 270-degree range is detected by the laser scanner, and the laser beam is irradiated to the light reference area within a 90-degree range to calculate an error of the scan beam depending external environments such as a circuit delay time, a temperature, and reflectivity.

Specifically, when the temperature of the light source emitting laser light (or laser beam) is changed, optical power decreases, and additional circuit delay occurs, resulting in a time difference between actual transmission of the laser light and generation of a light transmission signal, and thus, a distance error occurs due to the time difference.

In this case, like the light reference area, in the scan area, when the temperature of the light source is changed, a distance error may occur due to a decrease in optical power, and additional circuit delay may occur. Thus, if the distance error occurring on the light reference area is subtracted from a distance value measured on the scan area, the distance error on the scan area is canceled, and an accurate distance from the laser scan to the object on the scan area is calculated.

In order to calculate an accurate measurement distance on the actual scan area through the measurement distance error correction, the light reference area exists, and an optimized light reference path design on the light reference area is required.

In the case of the conventional laser scanner as disclosed in the prior art below, a rigid-flexible PCB to which a reference sheet is attached is disposed on an optical path on the light reference area to constitute the light reference.

In detail, the optical path may be understood to mean a movement path of the laser light that is irradiated from the light source and then reflected by the mirror disposed at an inclined angle at a predetermined angle.

In addition, the rigid-flexible PCB refers to a PCB in which a portion of a rigid PCB and a portion of a flexible PCB are combined, and a plurality of rigid boards are connected by the flexible board.

In addition, the reference sheet is mounted on the flexible PCB, and a white reference sheet is disposed on the path along which the laser light reflected from the mirror moves. Then, a portion of the laser light emitted from the light source (light-emitting element) and reflected by the mirror is reflected again by the reference sheet and then received by the light-receiving element.

In addition, a main control unit of the laser scanner analyzes the laser light received by the light-receiving element to obtain measurement distance information on the light reference area. In addition, the main control unit may calculate an exact distance between the laser scanner and the object on the scan area by correcting the error using the obtained distance information on the light reference area.

However, the conventional laser scanner in which the reference sheet is attached to the rigid-flexible PCB may have a structure in which the flexible PCB is provided between two rigid PCBs, and the reference sheet is attached to the flexible PCB, and a shape of the portion of the flexible PCB may be deformed depending on a length and assembly tolerance of each components.

In addition, the use of the rigid-flexible PCBs has a disadvantage of increasing in assembly difficulty and increasing in manufacturing cost.

In addition, there is a disadvantage that the accuracy of the light reference measurement distance information is significantly reduced because reflection of ambient light noise is transmitted as it is.

In addition, the light reflected from the reference sheet is directly received by a light receiver without the reflection of the ambient light noise, which makes it difficult to accurately measure the reference distance.

Prior Art: Japanese Patent Publication No. 2012-132917 (Jul. 12, 2012)

### DISCLOSURE OF THE INVENTION

### Technical Problem

The present invention has been proposed to improve the above-described limitations.

### Technical Solution

A laser scanner according to an embodiment of the present invention for achieving the above object includes: a housing; a window coupled to a top surface of the housing; a motor mounted on an inner upper end of the window; a mirror inclinedly connected to a rotary shaft to reflect light; a light source disposed below the mirror to irradiate laser beam toward the mirror; a PCB which is erected in a lateral direction of the mirror and has an opening through which the laser beam reflected from the mirror passes; a reference sheet which is erected inside the window and erected at a point that is spaced apart from the PCB in a horizontal direction to diffuse and reflect the laser beam passing through the opening; a light-transmissive lens disposed between the light source and the mirror to guide the laser beam emitted from the light source to the mirror; a light-receiving element configured to receive the laser beam that is diffused and reflected from at least the reference sheet to pass through the opening; and a light-receiving lens configured to concentrate the laser beam, which is diffused and reflected from the reference sheet to pass through the opening, into the light-receiving element.

A laser scanner according to another aspect of the present invention includes: a housing; a window coupled to a top surface of the housing; a motor mounted on an inner upper end of the window; a mirror inclinedly connected to a rotary shaft to reflect light; a light source disposed below the mirror to irradiate laser beam; a barrel part provided between the mirror and the light source and including an incident barrel part and a reflective barrel part; a reference sheet that is erected inside the window; a PCB which is erected between the mirror and the reference sheet and has an opening through which the laser beam passes; a light-transmissive lens configured to guide laser beam emitted from the light source to the incident barrel part; a light-receiving element configured to receive the laser beam diffused and reflected from at least the reference sheet; and a light-receiving lens configured to concentrate the laser beam, which is diffused and reflected from the reference sheet, into the light-receiving element, wherein the laser beam emitted from the light source passes through the light-transmissive lens and then is reflected from the mirror through the incident barrel part, the laser beam reflected from the mirror is emitted through the reflective barrel part, the laser beam emitted through the reflective barrel part is diffused and reflected from the reference sheet through the opening, and a portion of the light reflected from the reference sheet is received into the light-receiving lens after passing through the opening or is reflected from the mirror after the opening so as to be received into the light-receiving lens.

### Advantageous Effects

The laser scanner according to the embodiment of the present invention, which is configured as described above, has the following effects or advantages.

First, the reference light may pass through the opening defined in the encoder PCB and be reflected from the reference sheet, and a portion of the light reflected from the reference sheet may pass through the opening again and be received by the light receiver, there may be advantage of obtaining the noise reflection effect from the surroundings by the encoder PCB. That is, since there is the separation space between the reference sheet and the encoder PCB, there may be the advantage in that the ambient light of the light reflected from the reference sheet is reflected from the encoder PCB to remove the noise light.

Second, the light reference configuration of the present invention may have the advantage of having the simple and optimized characteristics compared to the conventional light reference configuration.

Third, since the general rigid PCB is used as it is, the cost savings may be achieved, and the assembly may be excellent.

### BRIEF DESCRIPTION OF THE DRAWINGS

FIG. 1 is a perspective view of a laser scanner according to an embodiment of the present invention.

FIG. 2 is a longitudinal cross-sectional view taken along line 2-2 of FIG. 1.

FIG. 3 is a view illustrating a movement path of light on a light reference area of the laser scanner according to an embodiment of the present invention.

FIG. 4 is a view illustrating a movement path of light on a monitoring area of the laser scanner according to an embodiment of the present invention.

### MODE FOR CARRYING OUT THE INVENTION

Hereinafter, a laser scanner according to an embodiment of the present invention will be described in detail with reference to the accompanying drawings.

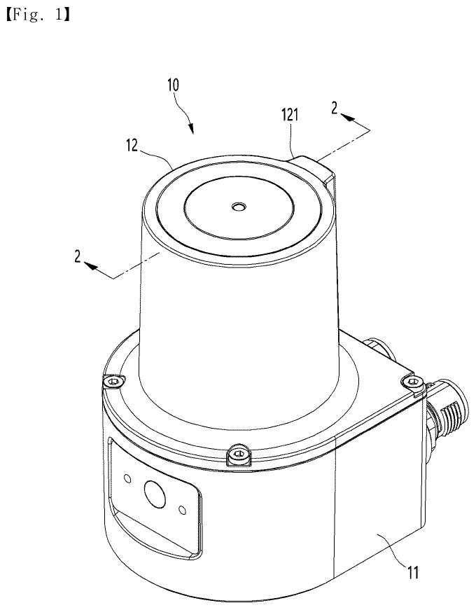

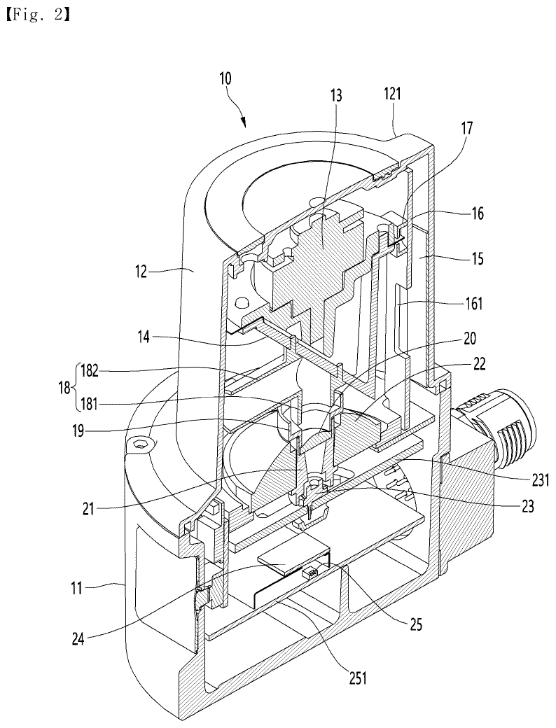

FIG. 1 is a perspective view of a laser scanner according to an embodiment of the present invention, and FIG. 2 is a longitudinal cross-sectional view taken along line 2-2 of FIG. 1.

Referring to FIGS. 1 and 2, a laser scanner 10 according to an embodiment of the present invention includes a housing 11 and a window 12 coupled to a top surface of the housing 11, all components are accommodated in an inner space defined by the housing 11 and the window 12.

In detail, the laser scanner 10 includes a motor 13 mounted on an inner upper end of the window 12, a mirror 14 that is inclinedly connected to a rotary shaft of the motor 12 at a predetermined angle, and an encoder PCB 16 that is erected on one side surface of the window 12.

A reference sheet seating part 121 protrude from one side surface of the window 12. The reference sheet seating part 121 may extend from an upper end to a lower end of the window 12 with a predetermined width in a circumferential direction of the window 12.

The window 12 may allow infrared rays reflected from the mirror 14 to pass therethrough and block visible light penetrated from the outside and may have a truncated cone shape of which a cross-sectional area increases from a top surface to a lower end thereof.

The laser scanner 10 further includes a reference sheet 15 mounted inside the reference sheet seating part 121. The reference sheet 15 may be understood as a diffusion sheet that diffuses light reflected from the mirror 14 toward the mirror 14 or a reflective sheet that re-reflects the light reflected from the mirror toward the mirror 14.

The reference sheet 15 may be in close contact with the reference sheet seating part 121 and be inclined erected at an angle corresponding to the inclined angle of the reference sheet seating part 121. In addition, when the window 121 including the reference sheet seating part 121 has a cylindrical shape, the reference sheet 16 may be inclinedly erected by itself inside the reference sheet seating part 121.

The encoder PCB 16 is disposed to be spaced a predetermined distance from the reference sheet 15 in a central direction of the window 12. In addition, an encoder 17 that detects a rotation angle of the motor 13 is mounted on an upper end of the encoder PCB 16, and the encoder 17 may be defined as an angle measuring part. In addition, a driver IC for driving the motor 13 may be mounted on a light source PCB 231, which will be described later.

In addition, an opening 161 is defined in the encoder PCB 16, and a function of the opening 161 will be described later. In addition, since the reference sheet 15 is disposed to be space a predetermined distance from the encoder PCB 16, a portion of the light that is re-reflected and diffused from the reference sheet 15 may collide with the encoder PCB 16 and is extinguished, and only a portion of the light is inclined into a reflective surface of the mirror 14 or a light-receiving lens, which will be described later, through the opening 161.

The laser scanner 10 further includes a barrel part 18 coupled to approximately a center of a bottom surface of the mirror 14.

In detail, the bottom surface of the mirror 14 functions as a reflective surface that reflects laser light emitted from a light source that will be described later. In addition, the barrel part 182 guides the light emitted from the light source to the reflective surface of the mirror 14 and also guide the laser light reflected from the mirror 14 so as to be emitted in a radial direction, i.e., in a horizontal direction of the window 12.

The barrel part 18 includes an incident barrel part 181, which allows the light emitted from the light source to be incident into the bottom surface of the mirror 14, and a reflective barrel part 182, which allows the light incident into the bottom surface of the mirror 14 to be re-incident in the horizontal direction through the incident barrel part 181.

According to the principle of the incidence and reflection, an angle angled by the mirror 14 and the incident barrel part 181 is the same as an angle angled by the mirror 14 and the reflective barrel part 182.

In addition, a center of the reflective barrel part 182 is disposed above a center of the opening 161 so as to be designed so that the opening 161 corresponding to a lower side of the reflective barrel part 182 has an area greater than that of the opening 161 corresponding to an upper side of the reflective barrel part 182. As a result, most of the light reflected from the reference sheet 15 and passing through the opening 161 is directly incident into the light-receiving lens 22 through the lower space of the opening 161. In addition, a relatively small amount of light passes through the upper space of the opening 161 and then is reflected by the mirror 14 so as to be incident into the light-receiving lens 22.

In addition, the laser scanner 10 further includes an aperture 19 mounted on a lower end of the incident barrel part 181, a barrel 21 vertically connected to a lower end of the aperture 19, a light-transmissive lens 20 disposed at a boundary point between the aperture 19 and the barrel 21, a light-receiving lens 22 having a recess (or protrusion) and a through-hole, in which the aperture 19 and the barrel 21 are accommodated, at a center thereof, and a light source 23 disposed on a lower end of the barrel 21. The recess is defined in an upper end of the through-hole, and a diameter of the recess is greater than that of the through-hole. The recess may be defined in the upper end of the through-hole to prevent an adhesive solution from overflowing to the top surface of the light-receiving lens 22 when the adhesive solution is injected between an inner circumferential surface of the through-hole and an outer circumferential surface of the barrel 21.

In addition, depending on design conditions, the recess may have a diameter equal to or greater than that of the upper end of the aperture 19 to prevent top surfaces of the aperture 19 and the light-receiving lens 22 from being in contact with each other.

In detail, the aperture 19 functions to fix the light-transmissive lens and block optical noise. The upper portion of the aperture 19 accommodates the lower end of the incident barrel part 181, and the lower portion of the aperture 19 is inserted into the barrel 21. In addition, an upper diameter of the aperture 19 may be greater than a lower diameter of the aperture 19. The lower end of the incident barrel part 181 may be accommodated inside the aperture 19, and the lower portion of the aperture 19 may be inserted into the barrel 21, and thus, an optical path from the light source 23 to the mirror 14 may be secure to prevent light from leaking to the outside. Furthermore, there is an effect of blocking an optical noise phenomenon in which the light received by the light-receiving lens 22 is introduced into the incident barrel part 181.

In addition, a protrusion is disposed on the inner circumferential surface of the upper end of the barrel 22, and the light-transmissive lens 20 is mounted on the protrusion. In addition, the lower end of the aperture 19 functions to press an edge of the light-transmissive lens 20 so that the light-transmissive lens 20 is stably fixed inside the barrel 21 without being shaken.

An optical passage 211 through which light passes is defined inside the barrel 21, and the optical passage 211 has a truncated cone shape that is expanded from the lower end to the upper end of the barrel 21.

In addition, a light source accommodation groove in which the light source 23 is accommodated is defined inside the lower portion of the barrel 21, and an upper end of the light source accommodation groove communicates with the light passage 211.

The light source 23 may be a laser diode that emits laser beam, and the light source 23 is mounted on the light source PCB 231. In addition, as described above, the driver IC that drives the motor 13 may also be mounted on the light source PCB 231.

The light-transmissive lens 20 may function of concentrating the beam diffused from the light source 23 into parallel beam, and thus, this function may be defined as a beam shaping. That is, the laser beam that is diffused while being emitted from the light source 23 is shaped into the parallel light or linear light while passing through the light-transmissive lens 20 and then is irradiated into the mirror 14. For beam shaping, the top surface of the light-transmissive lens 20, that is, a light emission surface may be provided in a rounded convex lens shape.

The recess (or protrusion) in which the lower portion of the aperture 19 is accommodated is provided at the center of the top surface of the light-receiving lens 22, and an insertion hole into which the barrel 21 is inserted is defined at the inner center. The light-receiving lens 22 may have a convex lens shape having a rounded top surface.

The laser scanner 10 may further include a band pass filter 24 disposed below the light source, and a light-receiving element 25 disposed below the band pass filter 24. The light-receiving element 25 is mounted on a light-receiving element PCB 251.

The band pass filter 24 blocks light having an unnecessary wavelength band of the light passing through the light-receiving lens 22 and incident into the light-receiving element 25.

The light-receiving element 25 may be an avalanche photo diode.

An operation of the laser scanner 10 according to an embodiment of the present invention will be described.

First, an assembly of the mirror 14 and the barrel part 18 rotates at a predetermined angular speed due to the rotation of the motor 13. As the mirror 14 rotates, the encoder 17 recognizes the rotation angle of the mirror 14. In addition, when the reflective barrel part 182 of the barrel part 18 passes through the monitor area and the light reference area, the laser beam is emitted from the light source 23 at an angular resolution interval of the encoder 17. In addition, the laser light is irradiated by an ultra-short set number of times at a time point at which the reflective barrel part 182 is aligned with a slit of the encoder 17.

The laser beam emitted through the reflective barrel part 182 is transmitted onto an object within the monitoring area or the reference sheet 15. In addition, the light transmitted onto the object or the reference sheet 15 on the monitoring area is reflected from the object or the reference sheet 15.

In addition, a portion of the light reflected and returned from the object or the reference sheet 15 passes through the window 12 and then is directly incident into the light-receiving lens 22 or is reflected by the mirror 14 and incident into the light-receiving lens 22. In addition, a portion of the light incident into the light-receiving lens 22 is filtered while passing through the band pass filter 24 and then received by the light-receiving element 25.

In addition, when measuring a time difference between a time point at which the light transmission signal (light emission signal) is generated from the light source 23 and a time point at which a light receiving signal is generated from the light-receiving element 25, a distance (object detection distance) between the object and the light source 23 and a distance (light reference distance) between the reference sheet 15 and the light source 23 are calculated.

In addition, when subtracting the light reference distance from the object detection distance, an exact actual distance from the laser scanner 10 to the object is calculated. As described above, the light reference distance corresponds to a measurement distance error caused by changes in temperature of the light source, etc., and thus, the light reference distance corresponding to the measurement distance error is subtracted from the object detection distance.

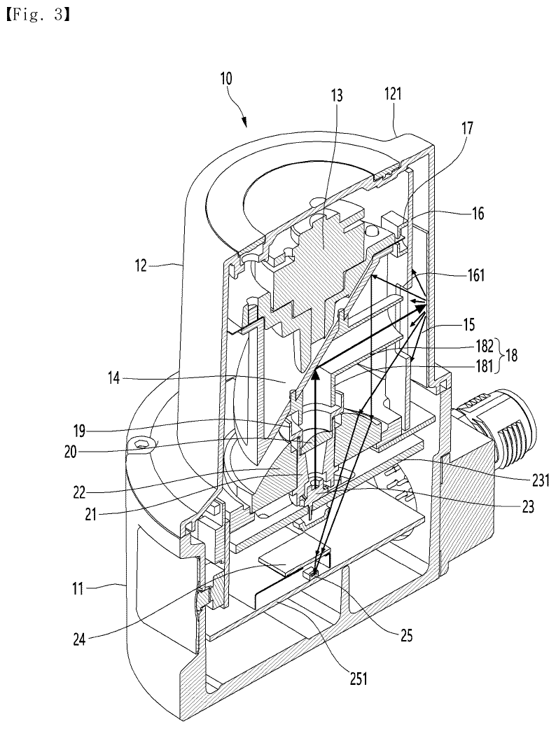

FIG. 3 is a view illustrating a movement path of light on the light reference area of the laser scanner according to an embodiment of the present invention.

Referring to FIG. 3, when the reflective barrel part 182 of the barrel part 18 enters a light reference section, and the reflective barrel part 182 and the opening 161 of the encoder PCB 16 are aligned on the same line, as described above, the laser beam is emitted from the light source 23.

The laser beam emitted from the light source 23 is shaped into the parallel light while passing through the light passage 211 inside the barrel 21 and the light-transmissive lens 20, and the parallel light passing through the light-transmissive lens 20 is incident into the reflective surface of the mirror 14 through the incident barrel part 181.

Then, the laser beam incident into the reflective surface of the mirror 14 is reflected at an angle equal to the incident angle to pass through the reflective barrel part 182 and the opening 161 and then is irradiated to the reference sheet 15.

In addition, the laser beam irradiated to the reference sheet 15 is diffused toward the opening 161, a portion of the diffused light is irradiated to the encoder PCB 16 and is extinguished, and a remaining portion is radiated or directly incident into the light-receiving lens 22 after passing through the opening 161. Here, due to setting of a size and position of the opening 161, it is designed that an amount of light directly incident into the light-receiving lens 22 among the light passing through the opening 161 is greater than that of the light incident into the light-receiving lens 22 after colliding with the mirror 14.

In addition, the reference sheet 15 is preferably designed to be larger than the opening 161 so that the light passing through the opening 161 is reflected from the reference sheet 15 without leaking.

In the case of the laser scanner having the conventional light reference structure, there may be no function to remove the noise light of the light diffused from the reference sheet 15. However, as illustrated in the drawings, the reference sheet 15 of the present invention may be disposed to be spaced apart from the encoder PCB 16 to obtain an effect in which a portion (noise light) of the light diffused and reflected from the reference sheet 15 is removed by the encoder PCB 16.

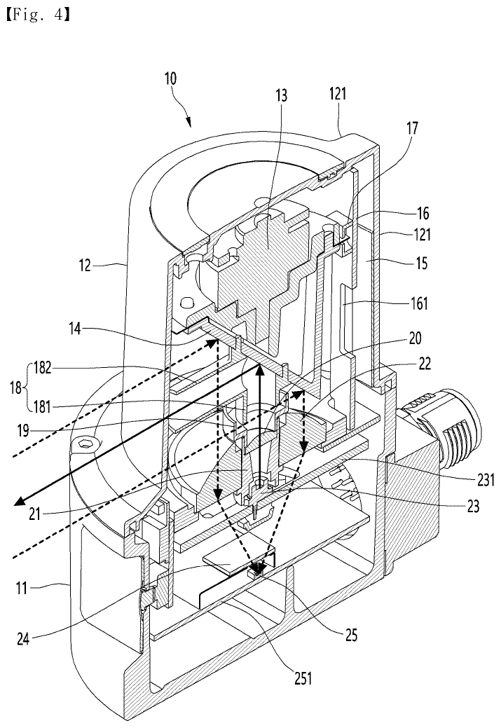

FIG. 4 is a view illustrating a movement path of light on the monitoring area of the laser scanner according to an embodiment of the present invention.

Referring to FIG. 4, the laser beam emitted from the light source 23 passes through the barrel 22, the light-transmissive lens 20, and the incident barrel part 181 and then is reflected by the mirror 14. The laser beam reflected from the mirror 14 is emitted to the outside of the window 12 through the reflecting barrel part 182. The laser beam emitted to the outside of the window 12 is reflected after hitting an object (obstacle or dangerous substance) within the monitoring area and then is incident again into the window 12. Most of the light incident inside the window 12 is reflected by the mirror 14 and then is incident into the light-receiving lens 22.

1. A laser scanner comprising:
a housing;
a window coupled to a top surface of the housing;
a motor mounted on an inner upper end of the window;
a mirror inclinedly connected to a rotary shaft to reflect light;
a light source disposed below the mirror to irradiate laser beam toward the mirror;
a PCB which is erected in a lateral direction of the mirror and has an opening through which the laser beam reflected from the mirror passes;
a reference sheet which is erected inside the window and erected at a point that is spaced apart from the PCB in a horizontal direction to diffuse and reflect the laser beam passing through the opening;
a light-transmissive lens disposed between the light source and the mirror to guide the laser beam emitted from the light source to the mirror;
a light-receiving element configured to receive the laser beam that is diffused and reflected from at least the reference sheet to pass through the opening; and
a light-receiving lens configured to concentrate the laser beam, which is diffused and reflected from the reference sheet to pass through the opening, into the light-receiving element.

2. The laser scanner according to claim 1, wherein the reference sheet is disposed to be inclined from a vertical surface at a predetermined angle.

3. The laser scanner according to claim 1, wherein a reference sheet seating part on which the reference sheet is disposed is provided on a side surface of the window.

4. The laser scanner according to claim 3, wherein the reference sheet seating part radially protrudes from the side surface of the window with a predetermined width and extends in an axial direction of the window.

5. The laser scanner according to claim 1, further comprising a barrel part mounted at a center of a reflective surface of the mirror to rotate as one body with the mirror,
wherein the barrel part comprises:
an incident barrel part configured to guide the laser beam emitted from the light source to the reflective surface of the mirror; and
a reflective barrel part configured to guide the laser beam reflected from the mirror in the horizontal direction,
wherein the reflective barrel part is disposed between an upper end and a lower end of the opening.

6. The laser scanner according to claim 5, wherein a center of the reflective barrel part is disposed above a center of the opening.

7. The laser scanner according to claim 5, wherein an area of the opening corresponding to a lower side of the reflective barrel part is greater than that of the opening corresponding to an upper side of the reflective barrel part.

8. The laser scanner according to claim 5, further comprising:
an aperture having a space, in which a lower end of the incident barrel part is accommodated; and
a barrel having an upper side, into which the light-transmissive lens is inserted, and a lower side, into which the light source is inserted, the barrel having a light path configured to connect the light source to the light-transmissive lens therein,
wherein the lower end of the incident barrel part is inserted into an upper portion of the aperture, and a lower portion of the aperture is in contact with an edge of a top surface of the light-transmissive lens.

9. The laser scanner according to claim 8, wherein a recess in which a lower portion of the aperture is accommodated and an insertion hole into which the barrel is inserted are defined at a center of the light-receiving lens.

10. The laser scanner according to claim 8, further comprising a band pass filter disposed below the light source to block light having an unnecessary wavelength band,
wherein the band pass filter is disposed between the light-receiving element and the light source.

11. The laser scanner according to claim 1, further comprising an encoder configured to detects a rotation angle of the motor and a driver IC configured to control driving of the motor.

12. A laser scanner comprising:
a housing;
a window coupled to a top surface of the housing;
a motor mounted on an inner upper end of the window;
a mirror inclinedly connected to a rotary shaft to reflect light;
a light source disposed below the mirror to irradiate laser beam;
a barrel part provided between the mirror and the light source and comprising an incident barrel part and a reflective barrel part;
a reference sheet that is erected inside the window;
a PCB which is erected between the mirror and the reference sheet and has an opening through which the laser beam passes;
a light-transmissive lens configured to guide laser beam emitted from the light source to the incident barrel part;
a light-receiving element configured to receive the laser beam diffused and reflected from at least the reference sheet; and
a light-receiving lens configured to concentrate the laser beam, which is diffused and reflected from the reference sheet, into the light-receiving element,
wherein the laser beam emitted from the light source passes through the light-transmissive lens and then is reflected from the mirror through the incident barrel part,
the laser beam reflected from the mirror is emitted through the reflective barrel part,
the laser beam emitted through the reflective barrel part is diffused and reflected from the reference sheet through the opening, and
a portion of the light reflected from the reference sheet is received into the light-receiving lens after passing through the opening or is reflected from the mirror after the opening so as to be received into the light-receiving lens.

13. The laser scanner according to claim 2, wherein a reference sheet seating part on which the reference sheet is disposed is provided on a side surface of the window.

14. The laser scanner according to claim 13, wherein the reference sheet seating part radially protrudes from the side surface of the window with a predetermined width and extends in an axial direction of the window.
